(19) United States
(12) Patent Application Publication
(10) Pub. No.: US 2017/0088462 A1
(43) Pub. Date: Mar. 30, 2017

(54) FIBER REINFORCED CONCRETE

(71) Applicants: Nemkumar BANTHIA, Vancouver, British Columbia (CA); ATLANTIS HOLDINGS LTD., Langley (CA)

(72) Inventor: Nemkumar BANTHIA, Vancouver (CA)

(21) Appl. No.: 15/312,612

(22) PCT Filed: May 25, 2015
(86) PCT No.: PCT/CA2015/050472

§ 371 Date: Nov. 18, 2016

Related U.S. Application Data
(60) Provisional application No. 62/002,777, filed on May 23, 2014.

(51) Int. Cl. C04B 16/06; C04B 24/38; C04B 22/06; C04B 22/00; B29B 17/02; C04B 28/04

(52) U.S. Cl. CPC C04B 16/0683; B29B 17/0206; C04B 28/04; C04B 22/06; C04B 22/0006; C04B 24/383; B29K 2067/003

(57) ABSTRACT

A cement-based mixture comprises a polymeric fiber. The polymeric fiber may be obtained from a recycled vehicle tire. The cement-based mixture may comprise between 0.1% and 1.0% polymeric fiber by mass of cement. The cement-based mixture may comprise about 0.4% polymeric fiber by mass of cement. The cement-based mixture may be a mortar or a concrete. The polymeric fiber may be polyethylene-terephthalate.

### BACKGROUND OF THE INVENTION

Field of the Invention

The present invention relates to a fiber reinforced concrete and, in particular, to a fiber reinforced concrete wherein the fiber is a polymeric fiber obtained from recycled tires.

Description of the Related Art

Compared to some other construction materials, for example metals and polymers, concrete is significantly more brittle and exhibits a poor tensile strength. Concrete may carry flaws and micro-cracks both in the material and at interfaces even before an external load is applied. These defects and micro-cracks may emanate from excess water, bleeding, plastic settlement, thermal and shrinkage strains and stress concentrations imposed by external restraints. Under an applied load, distributed micro-cracks may propagate, coalesce and align themselves to produce macro-cracks. When loads are further increased, conditions of critical crack growth are attained at tips of the macro-cracks and unstable and catastrophic failure may be precipitated. Under fatigue loads, concrete may crack easily, and cracks may create access routes for deleterious agents which may lead to early saturation, freeze-thaw damage, scaling, discoloration and steel corrosion.

The micro-cracking and macro-cracking processes described above can be favourably modified by adding short, randomly distributed fibers of various suitable materials. Fibers may not only suppress the formation of cracks, but also abate the propagation and growth of cracks. The resulting material, termed ‘fiber reinforced concrete’, is rapidly becoming a well-accepted mainstream construction material.

In a hardened state, when the fibers are properly bonded, the fibers interact with the concrete matrix at the level of micro-cracks and effectively bridge these cracks, thereby providing stress transfer media that delays the coalescence and unstable growth of the cracks. However, if the fiber volume fraction is sufficiently high, this may result in an increase in the tensile strength of the matrix beyond a bend-over-point (BOP).

Fiber reinforced concrete can be classified into two broad categories, namely, normal performance fiber reinforced concrete and high performance fiber reinforced concrete. In normal performance fiber reinforced concrete, with a low to medium volume fraction of fibers, the fibers do not enhance the tensile/flexural strength of the concrete and benefits of fiber reinforcement are limited to either a reduction in the plastic shrinkage crack control or to enhancement of energy absorption in the post-cracking regime only. In high performance fiber reinforced concrete, with a high volume fraction of fibers, benefits of fiber reinforcement are noted in an increased tensile strength, strain-hardening response before localization and enhanced ‘toughness’ beyond crack localization. A fiber volume fraction at which fibers can be expected to produce an increase in the tensile/flexural strength is disclosed by Banthia, N. and Sheng, J., Fracture Toughness of Micro-Fiber Reinforced Cement Composites, Cement and Concrete Composites, 18: pp. 251-269; 1996 as shown below:

$${V}_{f} \geq ( {V}_{{f}_{critical}} ) = \frac{1}{1 + \frac{{τ}_{fu}}{{σ}_{mu}} \frac{{l}_{f}}{{d}_{f}} ( {λ}_{1} {λ}_{2} {λ}_{3} - {α}_{1} {α}_{2} )} \qquad ( 1 )$$

where, τ_{fu} is the average interfacial bond strength at the interface, σₘᵤ is the tensile strength of the concrete matrix, l_{f} is the fiber length and d_{f} is the fiber diameter, λ₁, λ₂, λ₃ are efficiency factors related to length, orientation and grouping, respectively, and α₁ and α₂ are constants pertaining to un-cracked state of the concrete. Equation 1 shows that, if the critical volume fraction is exceeded for a given fiber reinforced concrete, the fiber reinforced concrete will depict strain hardening and show multiple cracking.

In fiber reinforced concrete with fiber volume fractions higher than the critical volume fraction, after the bend-over-point, multiple cracking is expected to occur and the concrete is expected to crack in segments of lengths between x and 2x (where x is the transfer) length given by Equation 2 below.

$$x = 2 ( \frac{{V}_{m}}{{V}_{f}} ) ( \frac{{σ}_{mu}}{{τ}_{fu}} ) ( \frac{{d}_{f}}{4} ) \qquad ( 2 )$$

However, due to the excellent ability of fibers to control crack growth and provide crack-tip toughening, the fatigue performance of concrete may be significantly enhanced by fiber reinforcement with proper fiber volume fraction and fiber dispersion. Both diffusion and permeability may be controlled due to fiber reinforcement and corrosion may be delayed.

U.S. Pat. No. 7,267,873 which issued on Sep. 11, 2007 to Pilakoutas et al. discloses fiber reinforced concrete provided with thin steel fibers of a diameter between 0.05 mm and 0.3 mm that may be obtained from recycled tires. Two alternatives are suggested to avoid the problem of balling when mixing the fibers into the concrete. The first consists of the use of strands of fiber which demonstrate excellent bond characteristics. The second consists of the use of a mixture of fiber lengths and thicknesses, giving a wide distribution of l/d ratios not exceeding 250, which has the effect of reducing balling tendency so that significant densities can be achieved.

There however remains a need for improved admixtures and mixing techniques for fiber reinforced concrete. There also remains a need to fully understand admixture performance in service and optimize these composites for enhanced durability and endurance.

### SUMMARY OF THE INVENTION

It is an object of the present invention to provide fiber reinforced concrete wherein the fiber is a polymeric fiber obtained from recycled vehicle tires.

There is accordingly provided a cement-based mixture comprising a polymeric fiber. The polymeric fiber may be obtained from a recycled vehicle tire. The cement-based mixture may comprise between 0.1% and 1.0% polymeric fiber by mass of cement. The cement-based mixture may comprise about 0.4% polymeric fiber by mass of cement. The cement-based mixture may be a mortar or a concrete. The polymeric fiber may be polyethylene-terephthalate.

The polymeric fiber may be obtained by separating the polymeric fiber using gravitational methods. The polymeric fiber may be obtained by separating the polymeric fiber using solvents. The polymeric fiber may be added to the cement-based mixture by blowing the cement-based mixture into a concrete mixer.

The polymeric fiber may be dispersed in the cement-based mixture by using fine cements; using a dispersing agent selected from the group of dispersing agents including carboxyl methyl cellulose, silica fume, and ground blast furnace slag; using a high shear mixer rotating at very high speed; and/or using particular batching sequences in which the components are introduced into the mixer in a specific order for a better fiber dispersion and minimize entanglement of the polymeric fiber.

### BRIEF DESCRIPTIONS OF DRAWINGS

The invention will be more readily understood from the following description of the embodiments thereof given, by way of example only, with reference to the accompanying drawings, in which:

FIG. 1 is a photograph of scrap tire fiber fluff obtained by recycling tires;

FIG. 2 comprises scanning electron microscope images of the scrap tire fluff of FIG. 1;

FIG. 3 is a graph showing that the primary organic composition of the scrap tire fiber fluff is polyethylene-terephthalate;

FIG. 4 is a perspective view of a substrate base used to test plastic shrinkage cracking of fiber reinforced mortar;

FIG. 5 is a perspective view of the substrate base with fiber reinforced mortar overlay used to test plastic shrinkage cracking of the fiber reinforced mortar;

FIG. 6 is a graph showing the maximum crack width in fiber reinforced mortar including either scrap tire fiber fluff (STF) or commercially available virgin polyethylene-terephthalate (PET);

FIG. 7 is a graph showing a percentage reduction in crack width in fiber reinforced mortar including either scrap tire fiber fluff (STF) or commercially available virgin polyethylene-terephthalate (PET);

FIG. 8 is a graph showing a total crack area in specimens in fiber reinforced mortar including either scrap tire fiber fluff (STF) or commercially available virgin polyethylene-terephthalate (PET); and

FIG. 9 is a graph showing a percentage reduction in total crack area in fiber reinforced mortar including either scrap tire fiber fluff (STF) or commercially available virgin polyethylene-terephthalate (PET).

### DESCRIPTIONS OF THE PREFERRED EMBODIMENTS

Polymeric fibers obtained from recycling tires are useful as concrete reinforcement. Such fibers are expected to control shrinkage cracking, abate micro-cracks from coalescing and enhance ductility, toughness, impact resistance and fatigue endurance. With their high resistance to crack nucleation and growth, such fibers may reduce the permeability of concrete and prevent the ingress of deleterious agents thereby potentially delaying both material degradation and steel corrosion.

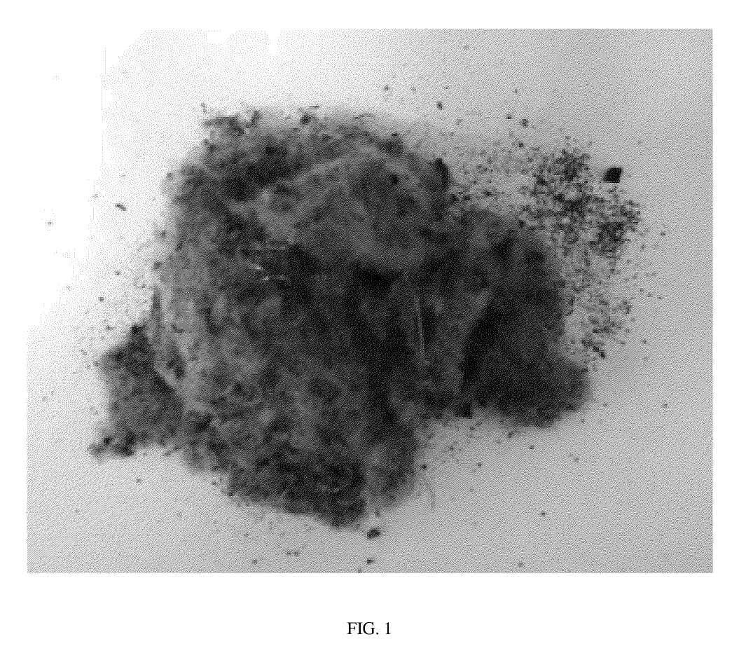

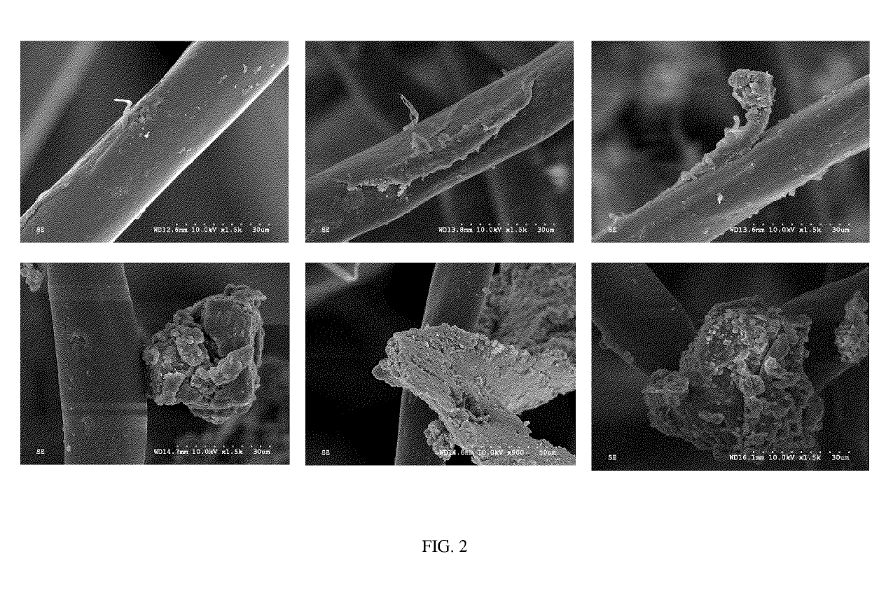

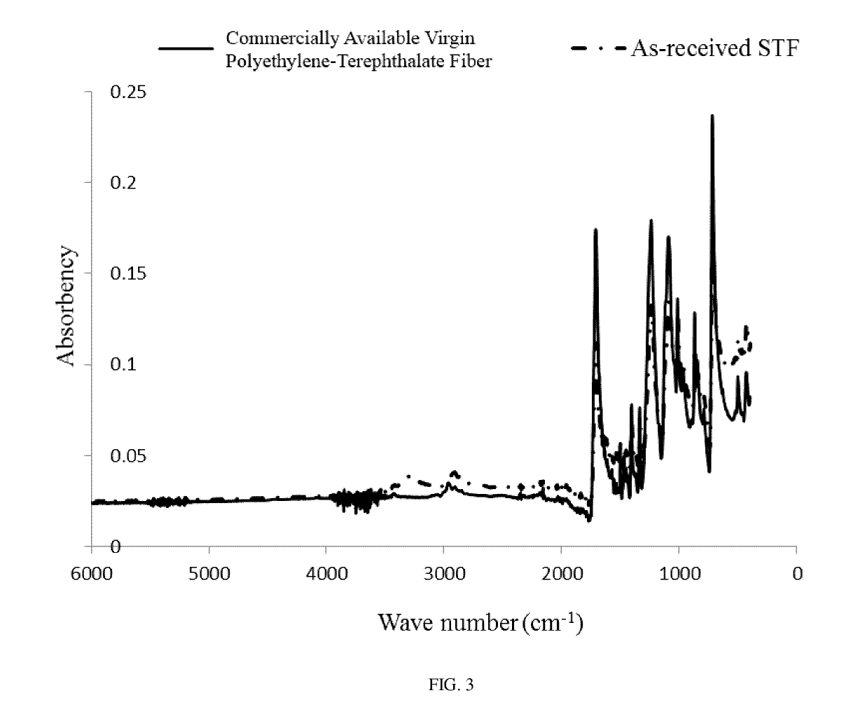

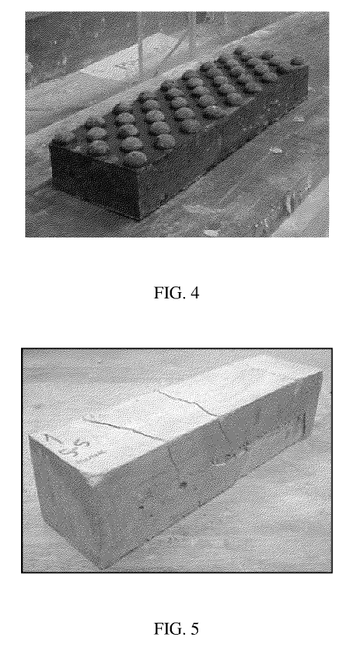

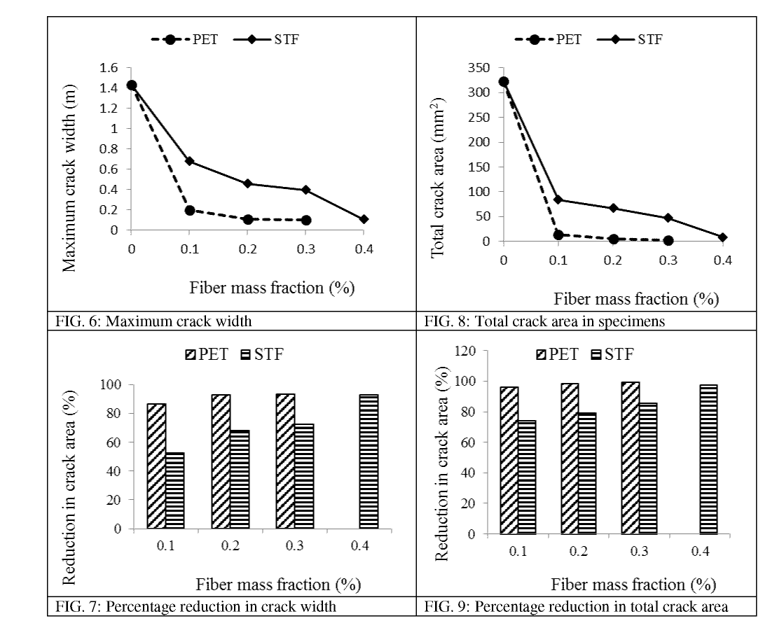

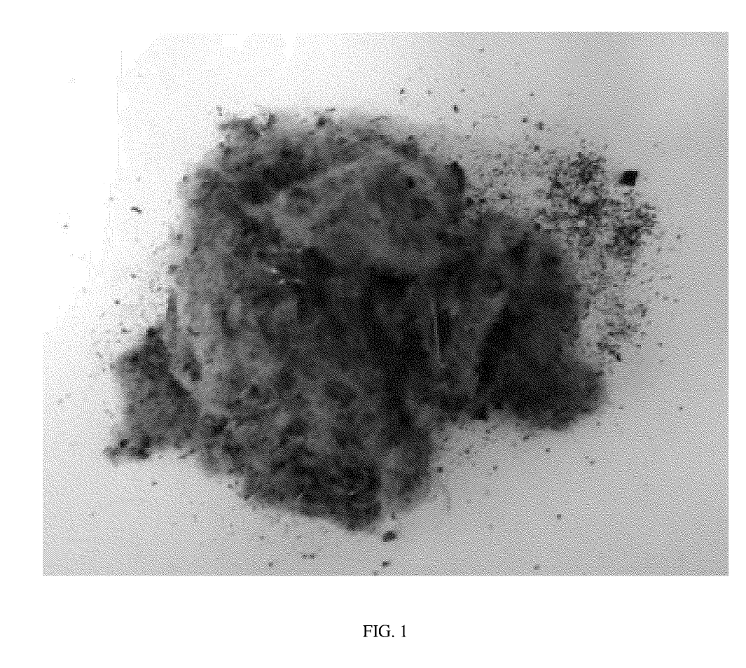

FIG. 1 shows scrap tire fiber fluff which was obtained from vehicle tires by Western Rubber Products Ltd. at 969 Cliveden Avenue, Delta, British Columbia, Canada V3M 5R6 using conventional recycling methods. When tires are recycled they are conventionally sliced and converted to successively smaller and smaller size crumb rubber. Abrasion from the cutting tool may produce air-borne polymeric fibers that are then collected and bagged. These polymeric fibers typically include polyester, rayon, nylon, etc. The polymeric fibers are separated from impurities such as crumb rubber by using gravitational methods or solvents.

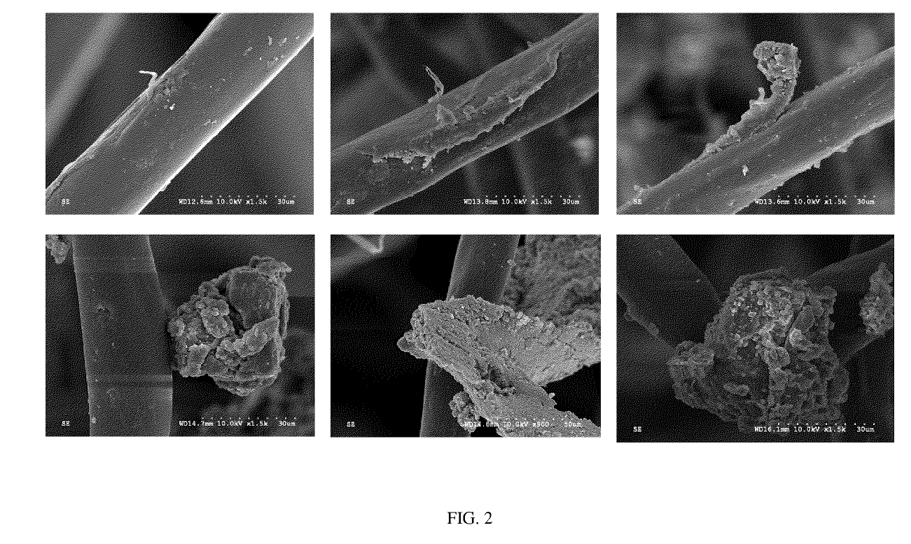

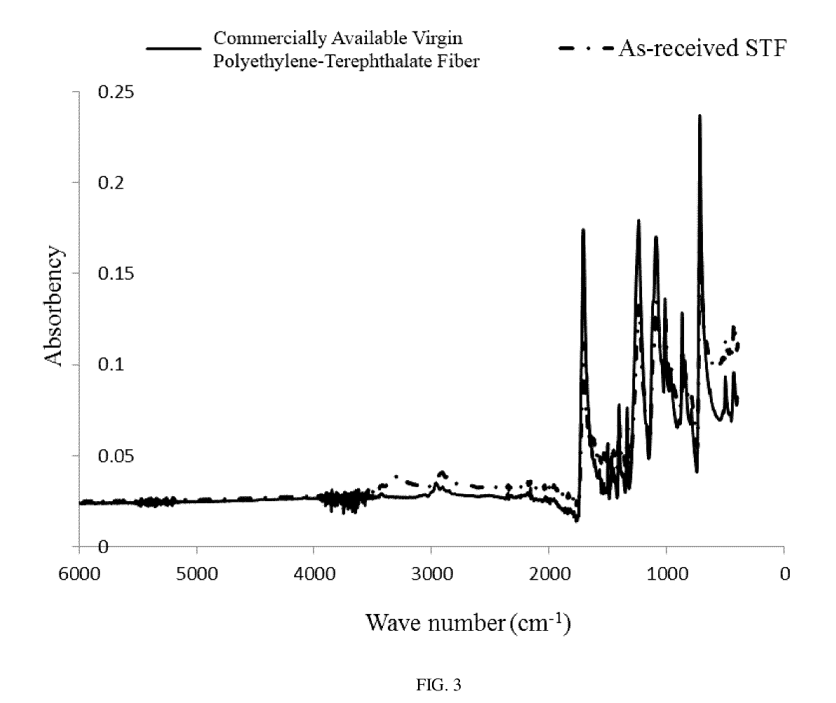

The scrap tire fiber fluff typically contains traces of crumb rubber particles and steel fibers which were not separated from the polymeric fibers during the recycling process. FIG. 2 shows scanning electron microscope (SEM) images of the scrap tire fiber fluff with adhered crumb rubber particles and surface damage to some of the fibers. FIG. 3 shows that the primary organic composition of the scrap tire fiber fluff was determined to be polyethylene-terephthalate, i.e. polyester, according to the ASTM (1998). Table 1 below shows some of the physical properties of the scrap tire fiber fluff as compared to commercially available virgin polyethylene-terephthalate fiber for concrete reinforcement.

TABLE 1
FIBER PROPERTIES

| | Equivalent | | Specific |
|---|---|---|---|
| Fiber Type | diameter (μm) | Length (mm) | gravity |
| Scrap tire fiber fluff | 18-20 | 3-5 | — |
| Commercially available virgin | 30-40 | 6 ± 0.3 | 1.36-1.37 |
| polyethylene-terephthalate | | | |

Mortar mixtures including scrap tire fiber fluff or commercially available virgin polyethylene-terephthalate fibers at 0.1%, 0.2%, 0.3% and 0.4% by mass of cement were prepared at a constant water-to-cement ratio and sand-to-cement ratio of 0.50. The scrap tire fiber fluff or commercially available virgin polyethylene-terephthalate fiber was first dispersed in mix water using carboxylated acrylic ester copolymer as a superplasticizer and a mechanical stirrer. Cement and fine aggregate were then added sequentially to the scrap tire fiber fluff or commercially available virgin polyethylene-terephthalate fiber suspensions. Ordinary Portland cement was used and the fine aggregate was natural sand with a specific gravity of 2.65. The mortar mixtures were preparing using a Hobart^{TM} mixture and the total mixing time was six minutes. Table 2 below shows the mortar mixtures used for overlays and substrate bases to test for shrinkage induced cracking in mortar including either scrap tire fiber fluff or commercially available virgin polyethylene-terephthalate fibers.

TABLE 2
MIX PROPORTIONS OF OVERLAYS
AND SUBSTRATE BASES BY MASS

| | | | | | | |
|---|---|---|---|---|---|---|
| | | | | | | Super- |
| | Silica | | | Aggre- | | plasti- |
| Cement | Fume | Water | Sand | gate | Fiber | cizer |

OVERLAYS

| | | | | | | | |
|---|---|---|---|---|---|---|---|
| Overlay with | 1 | 0 | 0.5 | 0.5 | 0 | 0.01 | 0.05 |
| 0.1% fiber | | | | | | | |
| by mass of | | | | | | | |
| cement | | | | | | | |
| Overlay with | 1 | 0 | 0.5 | 0.5 | 0 | 0.02 | 0.05 |
| 0.2% fiber | | | | | | | |
| by mass of | | | | | | | |
| cement | | | | | | | |
| Overlay with | 1 | 0 | 0.5 | 0.5 | 0 | 0.03 | 0.05 |
| 0.3% fiber | | | | | | | |
| by mass of | | | | | | | |
| cement | | | | | | | |
| Overlay with | 1 | 0 | 0.5 | 0.5 | 0 | 0.04 | 0.05 |
| 0.4% fiber | | | | | | | |
| by mass of | | | | | | | |
| cement | | | | | | | |

SUBSTRATE BASES

| | | | | | | | |
|---|---|---|---|---|---|---|---|
| Substrate | 1 | 0.11 | 0.30 | 1.51 | 1.51 | 0 | 0.04 |
| Bases | | | | | | | |

Plastic shrinkage induced cracking in the mortar mixtures was tested using a method developed at the University of British Columbia and disclosed in Banthia, N., Yan, C., and Mindess, S., Restrained Shrinkage Cracking in Fiber Reinforced Concrete: A Novel Test Technique, Cement and Concrete Research, 26(1), 1996, pp. 9-14; Banthia, N. and Campbell, K. Restrained Shrinkage Cracking in Bonded Fiber Reinforced Shotcrete, RILEM-Proc. 35, The Interfacial Transition Zone in Cementitious Composites, Eds. Katz, Bentur, Alexander and Arligui, E and F N. Spon, 1998, pp. 216-223; Banthia, N. and Gupta, P., Repairing with Fiber Reinforced Concrete Repairs, ACI Concrete International, 28(11), Nov 2006, pp. 36-40; and Banthia, N. and Gupta, R., Influence of Polypropylene Fiber Geometry on Plastic Shrinkage Cracking in Concrete, Cement and Concrete Research, 36 (7), July 2006, pp. 1263-1267. The full disclosures of the aforementioned references are incorporated herein by reference.

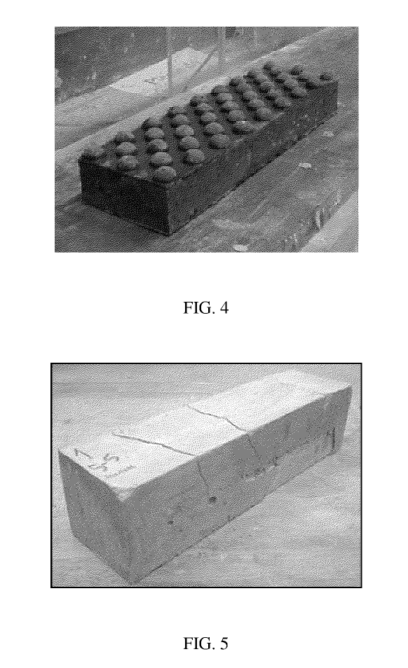

FIG. 4 shows an exemplar hardened substrate base which was used to test plastic shrinkage induced cracking in the mortar mixtures. The substrate base was cast with the mixture proportions provided in Table 2 above. The substrate bases were covered using a plastic sheet for twenty four hours then transferred to a tank with lime-saturated water and stored for at least sixty days. The substrate bases were then used to test for shrinkage induced cracking in mortar cast using the mortar mixtures provided in Table 2. The substrate bases used in this example had dimensions of 40 mm×95 mm×325 mm and a plurality of substantially semicircular protrusions on a planar surface thereof. The semicircular protrusions were 18.5 mm in diameter. The substrate bases had a compressive strength of 89 MPa when tested in accordance with ASTM C 39.

FIG. 5 shows the substrate base with an overlay of mortar mixture. The protrusions of the substrate base enhance the roughness of the substrate base and impose a uniform restraint on the overlay of mortar mixture. An overlay of fresh mortar mixture was placed directly on a hardened substrate base. The substrate base and overlay of mortar mixture were subjected to a drying environment to test for plastic shrinkage induced cracking. Mortar mixtures were used in testing for plastic shrinkage induced cracking because cracking in mortar is much more pronounced than cracking in concrete and the effects of fiber reinforcement are much more visible. It will be understood by a person skilled in the art that plastic shrinkage induced cracking in the mortar mixtures is indicative of expected plastic shrinkage induced cracking in concrete and other cement-based mixtures comprising either scrap tire fiber fluff or commercially available virgin polyethylene-terephthalate fibers.

Three specimens of a substrate base with an overlay of each of the mortar mixtures of Table 2 comprising either scrap tire fiber fluff or commercially available virgin polyethylene-terephthalate fibers were prepared using the following procedure. A cured, air-dried substrate base was placed in a polyvinylchloride (PVC) mould measuring 100 mm×100 mm×375 mm. A 60 mm deep overlay of mortar mixture, comprising either scrap tire fiber fluff or commercially available virgin polyethylene-terephthalate fibers, was then poured over the substrate base and finished with a trowel. The substrate base and the overlay were then transferred to an environmental chamber and demoulded after two hours to increase the surface area exposed to drying. The specimen was left in the environmental chamber for an additional twenty hours after which crack patterns developed in the overlay. Reference specimens comprising an overlay without either scrap tire fiber fluff or commercially available virgin polyethylene-terephthalate fibers were also prepared using a similar method.

An environmental chamber having dimensions of 1705 mm×1705 mm×380 mm was used to in the testing. The environmental chamber was provided with temperature probes and humidity probes capable of regulating and monitoring conditions inside the environmental chamber. Three heater blower units (240 volts, 4800 watts with a 1/30 HP, 1550 RPM internal electrical fan) supplied heated air to the environmental chamber. These units were, in turn, controlled by the temperature probes to maintain a constant temperature in the environmental chamber. The heated air was allowed to escape the chamber through three 240 mm×175 mm openings. A temperature of 50° C.±1° C. was maintained along with a relative humidity of about 5%. Under these conditions, an approximate rate of surface evaporation of 0.80 kg/m²/h was measured at the location of the specimen. Three specimens of a given overlay mixture were simultaneously tested.

Cracks developed on mortar overlays were characterized after twenty-four hours in the environmental chamber. A high magnification microscope with an accuracy of 0.01 mm was used for crack characterization. Crack widths and lengths were evaluated using image analysis software with a measurement accuracy of 0.001 mm. In addition to recording the maximum crack width observed in a given specimen, for each crack, the width was measured at several locations and averaged. Based on these width and length measurements, the maximum crack width and the total crack area of the reference mortar and the mortar including either scrap tire fiber fluff or commercially available virgin polyethylene-terephthalate fibers were determined. The inclusion of either scrap tire fiber fluff or commercially available virgin polyethylene-terephthalate fibers in the mortar mixtures was found to reduce shrinkage cracking significantly.

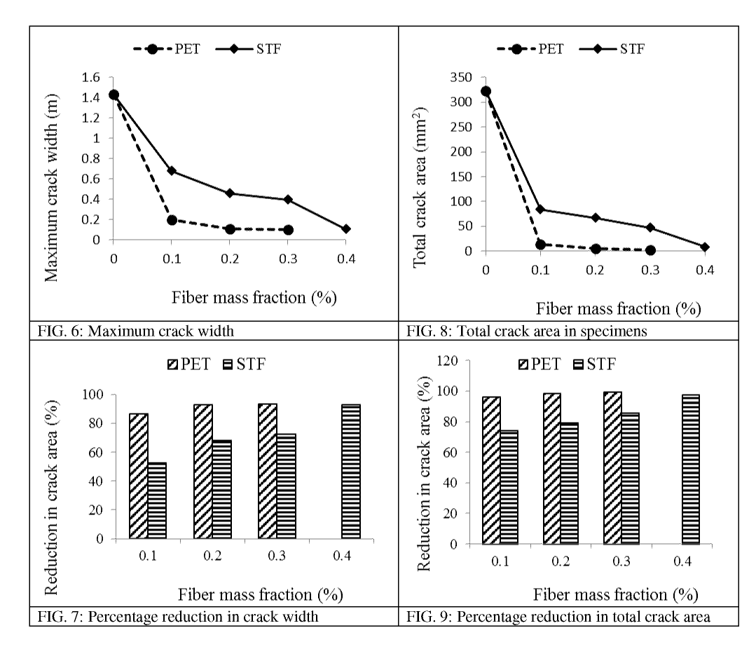

FIG. 6 shows that none of the specimens containing either scrap tire fiber fluff or commercially available virgin polyethylene-terephthalate fibers had cracks that were wider than 0.7 mm. FIG. 7 shows that the reductions in maximum crack width in comparison to the reference mortar ranged from 86.4% to 93.2% for specimens containing 0.1-0.3% commercially available virgin polyethylene-terephthalate fibers, the reductions in maximum crack width in comparison to the reference mixture for specimens containing 0.1-0.4% scrap tire fiber fluff were 52.7%, 68.2%, 72.4% and 92.7%, respectively. FIG. 8 shows the total crack area of the specimens and indicates that scrap tire fiber fluff or commercially available virgin polyethylene-terephthalate fibers were very effective in reducing plastic shrinkage cracking. FIG. 9 shows that while 0.1-0.4% addition of that scrap tire fiber fluff to mortar mixtures induced approximately 74-97.5% reduction in total crack area, the reductions in total crack area of specimens containing 0.1-0.3% commercially available virgin polyethylene-terephthalate fibers varied from 96 to 99.4%. From the values shown in FIGS. 7 and 9, it appears that while the optimum commercially available virgin polyethylene-terephthalate fiber content is 0.2%, the optimum scrap tire fiber fluff content is 0.4%. Overall, 0.4% scrap tire fiber fluff could be used to achieve performance comparable to those of 0.3% commercially available virgin polyethylene-terephthalate fibers.

It is further believed that methods of separating polymeric fibers during the recycling of tires such as gravitation methods, where use is made of the differential density between the crumb and the polymeric fiber, or dissolution separation where solvents are used to remove the attached crumb from fiber surfaces would produce polymeric fibers suitable for reinforcing concrete. It also appears that methods of adding the polymeric fibers to concrete would result in better fiber dispersion. Given the high specific surface area of polymeric fibers and the highly tangled form they are expected to have, mixing by conventional means is not expected to be appropriate. The polymeric fibers when added would tend to ball and disperse non-uniformly.

For proper mixing, it is believed that there must be proper fiber delivery in the concrete matrix and proper fiber mixing and dispersion. Fiber delivery in the concrete matrix may be accomplished by blowing fibers into a concrete mixer. The polymeric fibers may require mechanical agitation for separation prior to blowing.

Fiber mixing and dispersion may be achieved by using the following techniques:

use of finer cements;
use of a suitable dispersing agent, for example, carboxyl methyl cellulose, silica fume, ground blast furnace slag;
use of a specialized type mixer such as a high shear mixer rotating at very high speed; and/or
particular batching sequences in which the components should be introduced into the mixer in a specific order for a better fiber dispersion and minimize entanglement of the polymeric fiber.

It is still further believed that with mixture modifications involving the use of chemical and mineral admixtures, mixtures can be obtained that have better durability and cracking resistance than concrete without fibers. Such fiber reinforced concrete, apart from its lower carbon foot-print, may also depict better crack control, improved energy absorption capability, enhanced impact resistance and better fatigue endurance. It still further appears that using specialized mixing techniques (such as high shear mixing), and appropriate changes in the mixture proportions, fiber contents of up to 1% by mass of cement should not pose a problem in mixability and fiber dispersion.

It will be understood by a person skilled in the art that many of the details provided above are by way of example only, and are not intended to limit the scope of the invention which is to be determined with reference to the following claims.

1-18. (canceled)

19. A cement-based mixture comprising between 0.1% and 1.0% polymeric fiber by mass of cement wherein the polymeric fiber is from a recycled vehicle tire and wherein the polymeric fiber is separated from crumb rubber of the recycled vehicle tire.

20. The cement-based mixture as claimed in claim 19, comprising 0.4% polymeric fiber by mass of cement.

21. The cement-based mixture as claimed in claim 19, wherein the cement-based mixture is a mortar.

22. The cement-based mixture as claimed in claim 19, wherein the cement-based mixture is a concrete.

23. The cement-based mixture as claimed in claim 19, wherein the polymeric fiber is polyethylene-terephthalate.

24. The cement-based mixture as claimed in claim 19, wherein the polymeric fiber is separated from the crumb rubber of the recycled vehicle tire using gravitational separation.

25. The cement-based mixture as claimed in claim 19, wherein the polymeric fiber is separated from the crumb rubber of the recycled vehicle tire using successive gravitational separation.

26. The cement-based mixture as claimed in claim 19, wherein the polymeric fiber is added to the cement-based mixture by blowing the polymeric fiber into a concrete mixer.

27. The cement-based mixture as claimed in claim 19, wherein the polymeric fiber is dispersed in the cement-based mixture by:
using finer cements;
using a dispersing agent selected from the group of dispersing agents including carboxyl methyl cellulose, silica fume, and ground blast furnace slag;
using a high shear mixer rotating at very high speed; and/or
using particular batching sequences in which ingredients of the cement-based mixture are introduced into a mixer in a specific order.

28. The cement-based mixture as claimed in claim 19, wherein the polymeric fiber is collected as air-borne polymeric fiber produced by slicing of vehicle tires during a recycling.

29. Use of a cement-based mixture comprising between 0.1% and 1.0% polymeric fiber by mass of cement wherein the polymeric fiber is from a recycled vehicle tire and the polymeric fiber is separated from crumb rubber of the recycled vehicle tire, for reduction in plastic shrinkage induced cracking.

30. A method of making a cement-based mixture, the method comprising:
separating polymeric fibre from crumb rubber of a recycled vehicle tire;
mixing the polymeric fibre with water, cement and aggregate to form the cement-based mixture;
wherein the cement-based mixture includes between 0.1% and 1.0% polymeric fiber by mass of cement.

31. The method as claimed in claim 30, wherein the cement-based mixture includes 0.4% polymeric fiber by mass of cement.

32. The method as claimed in claim 30, wherein separating the polymeric fiber from crumb rubber of the recycled vehicle tire is performed using gravitational separation.

33. The method as claimed in claim 30, wherein separating the polymeric fiber from crumb rubber of the recycled vehicle tire is performed using successive gravitational separation.

34. The method as claimed in claim 30, wherein mixing the polymeric fibre with water, cement and aggregate includes blowing the polymeric fiber into a concrete mixer.

35. The method as claimed in claim 30, wherein mixing the polymeric fibre with water, cement and aggregate includes dispersing the polymeric fibre;
using finer cements;
adding a dispersing agent selected from the group of dispersing agents including carboxyl methyl cellulose, silica fume, and ground blast furnace slag;
mixing using a high shear mixer rotating at very high speed; and/or
mixing using particular batching sequences in which ingredients of the cement-based mixture are introduced into a mixer in a specific order.

36. The method as claimed in claim 30, wherein separating polymeric fibre from crumb rubber of a recycled vehicle tire includes collecting air-borne polymeric fiber produced by slicing of vehicle tires during recycling.
